(19) United States
(12) Patent Application Publication
(10) Pub. No.: US 2025/0021233 A1
(43) Pub. Date: Jan. 16, 2025

(54) MEMORY MANAGEMENT METHOD, MEMORY STORAGE DEVICE AND MEMORY CONTROL CIRCUIT UNIT

(71) Applicant: PHISON ELECTRONICS CORP., Miaoli (TW)

(72) Inventor: Kok-Yong Tan, Miaoli County (TW)

(73) Assignee: PHISON ELECTRONICS CORP., Miaoli (TW)

(21) Appl. No.: 18/363,758

(22) Filed: Aug. 2, 2023

(30) Foreign Application Priority Data
Jul. 11, 2023 (TW) 112125880

(51) Int. Cl. G06F 3/06

(52) U.S. Cl. CPC G06F 3/0613; G06F 3/0634; G06F 3/0679

(57) ABSTRACT

A memory management method, a memory storage device and a memory control circuit unit are disclosed. The method includes: in an initialization operation, setting a first physical unit to be operated in a first operation mode, and in the first operation mode, the first physical unit is programmed based on a first programming mode; receiving a plurality of commands, and the commands includes a first command and a second command, the first command instructs to store first data to a first logical unit, and the second command instructs to mark second data stored in a second logical unit as invalid data; and in response to that a target condition is satisfied, setting the first physical unit to be operated in a second operation mode, and in the second operation mode, the first physical unit is programmable based on a second programming mode.

### CROSS-REFERENCE TO RELATED APPLICATION

This application claims the priority benefit of Taiwan patent application serial no. 112125880, filed on Jul. 11, 2023. The entirety of the above-mentioned patent application is hereby incorporated by reference herein and made a part of this specification.

### BACKGROUND

### Field of the Disclosure

The present disclosure relates to a memory management technology, and in particular to a memory management method, a memory storage device and a memory control circuit unit.

### Description of Related Art

Portable electronic devices such as mobile phones and notebook computers have developed rapidly in recent years, making consumers' demand for storage media also increase dramatically. Since the rewritable non-volatile memory module (for example, flash memory) has the characteristics of non-volatility of data, power saving, small size, and no mechanical structure, it is very suitable to be built in various portable electronic devices as mentioned above.

Some types of rewritable non-volatile memory modules may be configured with physical units (such as physical blocks) that support fast write mode. When it is necessary to quickly write data from the host system, these physical units may store data based on a programmed mode with a faster writing speed but a smaller data storage capacity, so as to improve the writing performance of the host system. When performing background data sorting, the data stored in these physical units may be moved or copied to other physical units for storage.

Generally speaking, for the convenience of management, the total number of physical units supporting the fast write mode in a rewritable non-volatile memory module is fixed, for example, accounting for 5% to 15% of the total physical units. When the host system executes continuous data writing, once the default physical units supporting the fast writing mode are used up, the writing speed of the host writing will be significantly reduced, and thus reducing the writing performance of the host writing.

### SUMMARY OF THE DISCLOSURE

The present disclosure provides a memory management method, a memory storage device and a memory control circuit unit, which may improve the writing performance of the host writing.

An exemplary embodiment of the present disclosure provides a memory management method, which is used for a rewritable non-volatile memory module. The rewritable non-volatile memory module includes a plurality of physical units. The memory management method includes: in an initialization operation, setting a first physical unit to be operated in a first operation mode, where in the first operation mode, the first physical unit is programmed based on a first programming mode; receiving a plurality of commands from the host system, where the commands include a first command and a second command, the first command instructs to store first data to a first logical unit, and the second command instructs to mark second data stored in a second logical unit as invalid data; and in response to that a target condition is satisfied, setting the first physical unit to be operated in a second operation mode according to the second command, where in the second operation mode, the first physical unit may be programmed based on a second programming mode, and the first programming mode is different from the second programming mode.

An exemplary embodiment of the present disclosure further provides a memory storage device, which includes a connection interface unit, a rewritable non-volatile memory module, and a memory control circuit unit. The connection interface unit is configured to be coupled to the host system. The rewritable non-volatile memory module includes a plurality of physical units. The memory control circuit unit is coupled to the connection interface unit and the rewritable non-volatile memory module. The memory control circuit unit is configured to: in an initialization operation, setting a first physical unit among the plurality of physical units to be operated in a first operation mode, where in the first operation mode, the first physical unit is programmed based on a first programming mode; receiving a plurality of commands from the host system, where the plurality of commands include a first command and a second command, the first command instructs to store first data into the first logical unit, and the second command instructs to mark second data stored in the second logical unit as invalid data; and in response to a target condition being satisfied, setting the first physical unit to be operated in the second operation mode according to the second command, where in the second operation mode, the first physical unit is programmable based on a second programming mode, and the first programming mode is different from the second programming mode.

An exemplary embodiment of the present disclosure further provides a memory control circuit unit for controlling a rewritable non-volatile memory module, where the rewritable non-volatile memory module includes a plurality of physical units, and the memory control circuit unit includes a host interface, a memory interface, and a memory management circuit. The host interface is coupled to a host system. The memory interface is coupled to the rewritable non-volatile memory module. The memory management circuit is coupled to the host interface and the memory interface. The memory management circuit is configured to: in an initialization operation, setting a first physical unit among the plurality of physical units to be operated in a first operation mode, where in the first operation mode, the first physical unit is programmed based on a first programming mode; receiving a plurality of commands from the host system, where the plurality of commands include a first command and a second command, the first command instructs to store first data into the first logical unit, and the second command instructs to mark second data stored in the second logical unit as invalid data; and in response to a target condition being satisfied, setting the first physical unit to be operated in the second operation mode according to the second command, where in the second operation mode, the first physical unit is programmable based on a second programming mode, and the first programming mode is different from the second programming mode.

Based on the above, in the initialization operation, the first physical unit in the rewritable non-volatile memory module may be set to be operated in the first operation mode to be programmed based on the first programming mode. Additionally, multiple commands may be received from the host system. The plurality of commands may include a first command and a second command. The first command instructs to store the first data into the first logic unit. The second command instructs to mark the second data stored in the second logical unit as invalid data. In particular, in response to the target condition being met, the first physical unit may be dynamically set to be operated in the second operation mode according to the second command and programmed based on the second programming mode. In this way, the writing performance of the host writing may be improved.

### BRIEF DESCRIPTION OF THE DRAWINGS

FIG. 1 is a schematic diagram of a host system, a memory storage device and an input/output (I/O) device according to an exemplary embodiment of the present disclosure.

FIG. 2 is a schematic diagram of a host system, a memory storage device and an I/O device according to an exemplary embodiment of the present disclosure.

FIG. 3 is a schematic diagram of a host system and a memory storage device according to an exemplary embodiment of the present disclosure.

FIG. 4 is a schematic diagram of a memory storage device according to an exemplary embodiment of the present disclosure.

FIG. 5 is a schematic diagram of a memory control circuit unit according to an exemplary embodiment of the present disclosure.

FIG. 6 is a schematic diagram of a management rewritable non-volatile memory module according to an exemplary embodiment of the present disclosure.

FIG. 7 is a schematic diagram illustrating changing the operation mode of the first physical unit according to an exemplary embodiment of the present disclosure.

FIG. 8 is a flowchart of a memory management method according to an exemplary embodiment of the present disclosure.

FIG. 9 is a flowchart of a memory management method according to an exemplary embodiment of the present disclosure.

FIG. 10 is a flowchart of a memory management method according to an exemplary embodiment of the present disclosure.

### DESCRIPTION OF EMBODIMENTS

Generally speaking, a memory storage device (also called a memory storage system) includes a rewritable non-volatile memory module and a controller (also called a control circuit). A memory storage device may be used with a host system such that the host system may write data to or read data from the memory storage device.

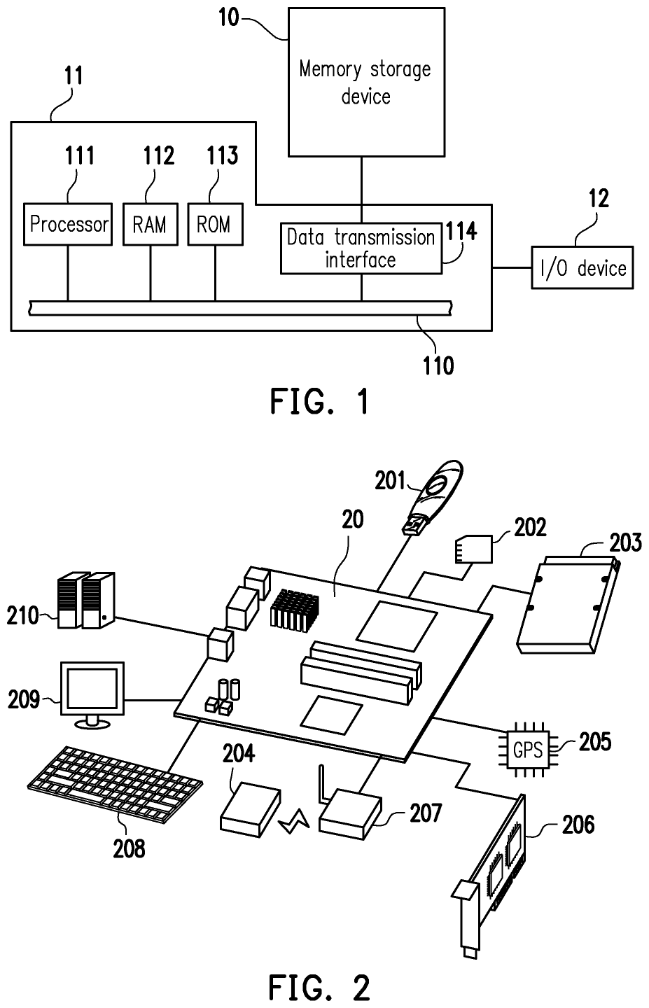

FIG. 1 is a schematic diagram of a host system, a memory storage device and an input/output (I/O) device according to an exemplary embodiment of the present disclosure. FIG. 2 is a schematic diagram of a host system, a memory storage device and an I/O device according to an exemplary embodiment of the present disclosure.

Please refer to FIG. 1 and FIG. 2, the host system 11 may include a processor 111, a random access memory (RAM) 112, a read-only memory (ROM) 113 and a data transmission interface 114. The processor 111, the RAM 112, the ROM 113 and the data transmission interface 114 may be coupled to a system bus 110.

In an exemplary embodiment, the host system 11 may be coupled to the memory storage device 10 through the data transmission interface 114. For example, the host system 11 may store data into the memory storage device 10 or read data from the memory storage device 10 through the data transmission interface 114. In addition, the host system 11 may be coupled to the I/O device 12 through the system bus 110. For example, the host system 11 may transmit output signals to the I/O device 12 or receive input signals from the I/O device 12 through the system bus 110.

In an exemplary embodiment, the processor 111, the RAM 112, the ROM 113 and the data transmission interface 114 may be disposed on the motherboard 20 of the host system 11. The number of data transmission interfaces 114 may be one or more. Through the data transmission interface 114, the motherboard 20 may be coupled to the memory storage device 10 in a wired or wireless manner.

In an exemplary embodiment, the memory storage device 10 may be, for example, a flash drive 201, a memory card 202, a solid state drive (SSD) 203 or a wireless memory storage device 204. The wireless memory storage device 204 may be, for example, a Near Field Communication (NFC) memory storage device, a Wireless Fax (WiFi) memory storage device, a Bluetooth memory storage device, or a Bluetooth low-power memory storage device (e.g., iBeacon) and other memory storage devices based on various wireless communication technologies. In addition, the motherboard 20 may also be coupled to various I/O devices such as a Global Positioning System (GPS) module 205, a network interface card 206, a wireless transmission device 207, a keyboard 208, a screen 209, and a speaker 210 through the system bus 110. For example, in an exemplary embodiment, the motherboard 20 may access the wireless memory storage device 204 through the wireless transmission device 207.

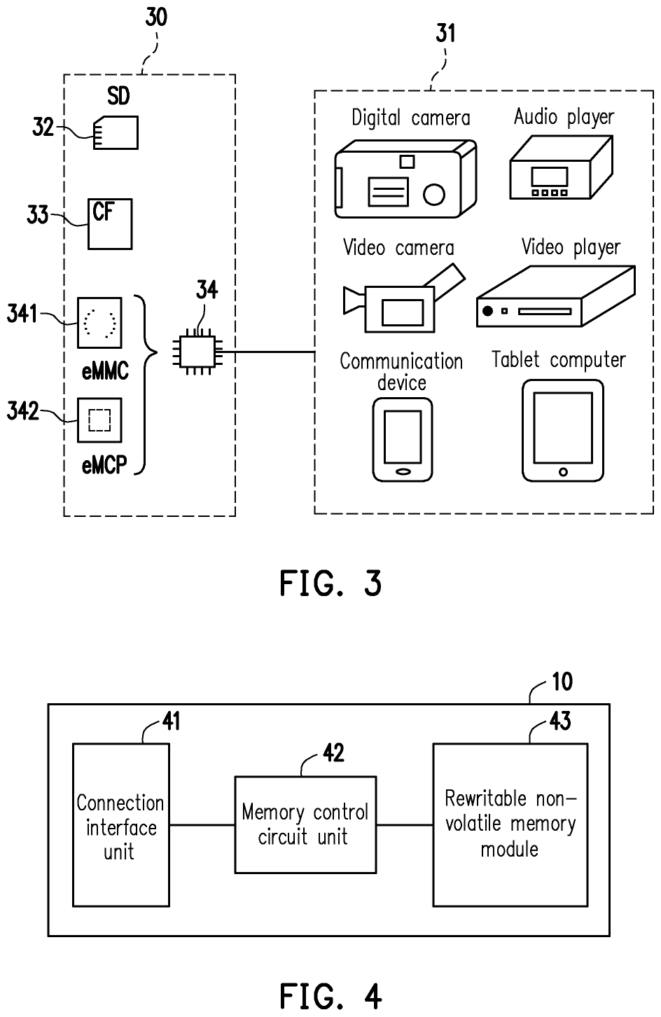

In an exemplary embodiment, the host system 11 is a computer system. In an exemplary embodiment, the host system 11 may be any system that can substantially cooperate with a memory storage device to store data. In an exemplary embodiment, the memory storage device 10 and the host system 11 may respectively include the memory storage device 30 and the host system 31 of FIG. 3.

FIG. 3 is a schematic diagram of a host system and a memory storage device according to an exemplary embodiment of the present disclosure. Referring to FIG. 3, the memory storage device 30 may be used together with the host system 31 to store data. For example, the host system 31 may be a digital camera, a video camera, a communication device, an audio player, a video player, or a tablet computer. For example, the memory storage device 30 may be various non-volatile memory storage devices such as a secure digital (SD) card 32, a compact flash (CF) card 33 or an embedded storage device 34 used by the host system 31. The embedded storage device 34 includes various types of embedded storage devices such as an embedded multi media card (eMMC) 341 and/or an embedded Multi Chip Package (eMCP) storage device 342, which directly couples the memory module to the substrate of the host system.

FIG. 4 is a schematic diagram of a memory storage device according to an exemplary embodiment of the present disclosure. Referring to FIG. 4, the memory storage device 10 includes a connection interface unit 41, a memory control circuit unit 42 and a rewritable non-volatile memory module 43.

The connection interface unit 41 is configured to couple the memory storage device 10 to the host system 11. The memory storage device 10 may communicate with the host system 11 through the connection interface unit 41. In an exemplary embodiment, the connection interface unit 41 is compatible with the high-speed Peripheral Component Interconnect Express (PCI Express) standard. In an exemplary embodiment, the connection interface unit 41 may also be in compliance with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, CF interface standard, Integrated Device Electronics (IDE) standard, or other suitable standards. The connection interface unit 41 and the memory control circuit unit 42 may be packaged in a chip, or the connection interface unit 41 is arranged outside a chip including the memory control circuit unit 42.

The memory control circuit unit 42 is coupled to the connection interface unit 41 and the rewritable non-volatile memory module 43. The memory control circuit unit 42 is configured to execute a plurality of logic gates or control commands implemented in hardware or firmware, and perform operations such as writing, reading and erasing data in the rewritable non-volatile memory module 43 according to the commands of the host system 11.

The rewritable non-volatile memory module 43 is configured to store the data written by the host system 11. The rewritable non-volatile memory module 43 may include a single-level memory cell (SLC) NAND flash memory module (that is, a flash memory module that may store 1 bit of data in a memory cell), a multi level cell (MLC) NAND flash memory module (that is, a flash memory module that may store 2 bits of data in a memory cell), a triple level cell (TLC) NAND flash memory module (that is, a flash memory module that may store 3 bits of data in a memory cell), a Quad Level Cell (QLC) NAND flash memory module (that is, a flash memory module that may store 4 bits of data in a memory cell), other flash memory modules or other memory modules with the same characteristics.

Each memory cell in the rewritable non-volatile memory module 43 stores one or more bits of data by changing a voltage (hereinafter also referred to as threshold voltage). Specifically, there is a charge trapping layer between the control gate and the channel of each memory cell. By applying a writing voltage to the control gate, the amount of electrons in the charge trapping layer may be changed, thereby changing the threshold voltage of the memory cell. The operation of changing the threshold voltage of the memory cell is also referred to as “writing data into the memory cell” or “programming the memory cell”. As the threshold voltage changes, each memory cell in the rewritable non-volatile memory module 43 has multiple storage states. By applying a read voltage to determine which memory cell belongs to which storage state, it is possible to store one or more bits of data stored in the memory cell.

In an exemplary embodiment, the memory cells of the rewritable non-volatile memory module 43 may form a plurality of physical programming units, and these physical programming units may form a plurality of physical erasing units. Specifically, the memory cells on the same word line may form one or more physical programming units. If each memory cell can store more than 2 bits of data, the physical programming units on the same word line may be at least classified into lower physical programming units and upper physical programming units. For example, the Least Significant Bit (LSB) of a memory cell belongs to the lower physical programming unit, and the Most Significant Bit (MSB) of a memory cell belongs to the upper physical programming unit. Generally speaking, in MLC NAND flash memory, the writing speed of the lower physical programming units is greater than that of the upper physical programming units, and/or the reliability of the lower physical programming units is higher than that of the upper physical programming units.

In an exemplary embodiment, the physical programming unit is the minimum unit to be programmed. That is, the physical programming units are the minimum unit for writing data. For example, a physical programming unit may be a physical page or a physical sector. If the physical programming units are physical pages, these physical programming units may include data bit areas and redundancy bit areas. The data bit area includes a plurality of physical sectors for storing user data, and the redundancy bit area is configured to store system data (e.g., management data such as error correction codes). In an exemplary embodiment, the data bit area includes 32 physical sectors, and the size of one physical sector is 512 bytes (B). However, in other exemplary embodiments, the data bit area may also include 8, 16 or more or less physical sectors, and the size of each physical sector may also be larger or smaller. On the other hand, the physical erasing unit is the minimum unit of erasing. That is, each physical erasing unit contains a minimum number of memory cells that are erased. For example, the physical erasing unit is a physical block.

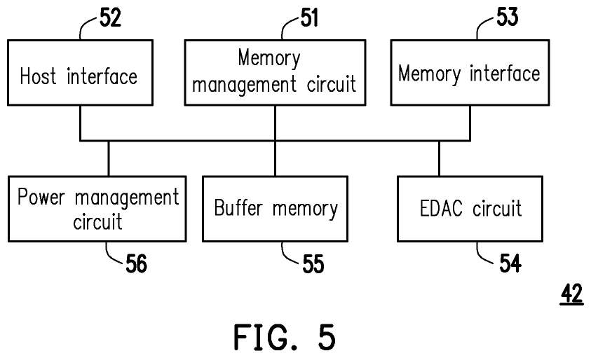

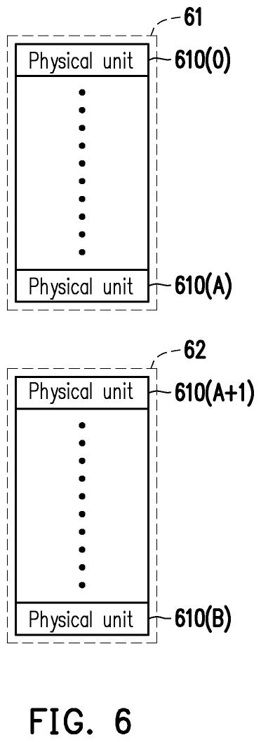

FIG. 5 is a schematic diagram of a memory control circuit unit according to an exemplary embodiment of the present disclosure. Please refer to FIG. 5, the memory control circuit unit 42 includes a memory management circuit 51, a host interface 52 and a memory interface 53.

The memory management circuit 51 is configured to control the overall operation of the memory control circuit unit 42. Specifically, the memory management circuit 51 has a plurality of control commands, and when the memory storage device 10 is operating, these control commands are executed to perform operations such as writing, reading and erasing data. When describing the operation of the memory management circuit 51 below, the description is equivalent to the description related to the operation of the memory control circuit unit 42.

In an exemplary embodiment, the control commands of the memory management circuit 51 are implemented in a firmware format. For example, the memory management circuit 51 has a microprocessor unit (not shown) and a read-only memory (not shown), and these control commands are burned into the read-only memory. When the memory storage device 10 is in operation, these control commands will be executed by the microprocessor unit to perform operations such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in a code format. In addition, the memory management circuit 51 has a microprocessor unit (not shown), a read-only memory (not shown) and a random access memory (not shown). In particular, the read-only memory has a boot code, and when the memory control circuit unit 42 is enabled, the microprocessor unit will first execute the boot code to load the control commands stored in the rewritable non-volatile memory module 43 into the random access memory of the memory management circuit 51. Afterwards, the microprocessor unit executes these control commands to perform operations such as writing, reading and erasing data.

In an exemplary embodiment, the control commands of the memory management circuit 51 may also be implemented in a hardware form. For example, the memory management circuit 51 includes a microcontroller, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microcontroller. The memory cell management circuit is configured to manage memory cells or memory cell groups of the rewritable non-volatile memory module 43. The memory writing circuit is configured to issue a write command sequence to the rewritable non-volatile memory module 43 to write data into the rewritable non-volatile memory module 43. The memory reading circuit is configured to issue a read command sequence to the rewritable non-volatile memory module 43 to read data from the rewritable non-volatile memory module 43. The memory erasing circuit is configured to issue an erase command sequence to the rewritable non-volatile memory module 43 to erase data from the rewritable non-volatile memory module 43. The data processing circuit is configured to process the data to be written into the rewritable non-volatile memory module 43 and the data read from the rewritable non-volatile memory module 43. The write command sequence, the read command sequence and the erase command sequence may respectively include one or more program codes or command codes and are configured to instruct the rewritable non-volatile memory module 43 to perform corresponding write, read and erase operations. In an exemplary embodiment, the memory management circuit 51 may also issue other types of command sequences to the rewritable non-volatile memory module 43 to instruct to execute corresponding operations.

The host interface 52 is coupled to the memory management circuit 51. The memory management circuit 51 may communicate with the host system 11 through the host interface 52. The host interface 52 may be used to receive and identify commands and data sent by the host system 11. For example, the commands and data sent by the host system 11 may be sent to the memory management circuit 51 through the host interface 52. In addition, the memory management circuit 51 may transmit data to the host system 11 through the host interface 52. In this exemplary embodiment, the host interface 52 is compatible with the PCI Express standard. However, it should be understood that the present disclosure is not limited thereto, and the host interface 52 may also be compatible with SATA standard, PATA standard, IEEE 1394 standard, USB standard, SD standard, UHS-I standard, UHS-II standard, MS standard, MMC standard, eMMC standard, UFS standard, CF standard, IDE standard or other suitable data transmission standards.

The memory interface 53 is coupled to the memory management circuit 51 and configured to access the rewritable non-volatile memory module 43. For example, the memory management circuit 51 may access the rewritable non-volatile memory module 43 through the memory interface 53. That is to say, the data to be written into the rewritable non-volatile memory module 43 will be converted into a format acceptable to the rewritable non-volatile memory module 43 through the memory interface 53. Specifically, if the memory management circuit 51 is to access the rewritable non-volatile memory module 43, the memory interface 53 will transmit the corresponding command sequence. For example, these command sequences may include a write command sequence for writing data, a read command sequence for reading data, an erase command sequence for erasing data, and corresponding command sequences for instructing various memory operations (for example, changing the read voltage level, etc.). These command sequences are, for example, generated by the memory management circuit 51 and sent to the rewritable non-volatile memory module 43 through the memory interface 53. These command sequences may include one or more signals, or data on the bus. These signals or data may include command codes or program codes. For example, in the read command sequence, information such as read identification code and memory address will be included.

In an exemplary embodiment, the memory control circuit unit 42 further includes an error detecting and correcting circuit 54, a buffer memory 55 and a power management circuit 56.

The error detecting and correcting circuit 54 is coupled to the memory management circuit 51 and configured to perform error detecting and correcting operations to ensure the correctness of the data. Specifically, when the memory management circuit 51 receives a write command from the host system 11, the error detecting and correcting circuit 54 will generate a corresponding error correcting code (ECC) and/or error detecting code (EDC) for the data corresponding to the write command, and the memory management circuit 51 will write the data corresponding to the write command and the corresponding error correcting code and/or error detecting code into the rewritable non-volatile memory module 43. Afterwards, when reading data from the rewritable non-volatile memory module 43, the memory management circuit 51 will simultaneously read the error correcting code and/or error detecting code corresponding to the data, and the error detecting and correcting circuit 54 will perform error detecting and correcting operations on the read data according to the error correcting code and/or error detecting code. For example, the error detecting and correcting circuit 54 may support various encoding/decoding algorithms such as Low Density Parity Check code (LDPC code) or BCH.

The buffer memory 55 is coupled to the memory management circuit 51 and configured to store data temporarily. The power management circuit 56 is coupled to the memory management circuit 51 and configured to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

The rewritable non-volatile memory module 43 may include multiple physical units. In an exemplary embodiment, a physical unit refers to a physical address or a physical programming unit. In an exemplary embodiment, a physical unit may also be composed of multiple continuous or discontinuous physical addresses. In an exemplary embodiment, a physical unit may also refer to a virtual block (VB). A virtual block may include multiple physical addresses or multiple physical programming units.

In an exemplary embodiment, the memory management circuit 51 may be configured with logical units to map physical units. In an exemplary embodiment, each logical unit corresponds to a logical address. For example, a logical address may include one or more logical block addresses (LBA) or other logical management units. In an exemplary embodiment, a logic unit may also correspond to a logic programming unit or consist of a plurality of continuous or discontinuous logical addresses.

It should be noted that a logical unit may be mapped to one or more physical units. If a physical unit is currently mapped by a logical unit, it means that the data currently stored in the physical unit includes valid data. Conversely, if a physical unit is not currently mapped by any logical unit, it means that the data currently stored in the physical unit is invalid. In addition, the logic-to-physical mapping information describing the mapping relationship between the logical unit and the physical unit may be recorded in the logical-to-physical mapping table. Then, the memory management circuit 51 may access the rewritable non-volatile memory module 43 according to the information in the logic-to-physical mapping table.

FIG. 6 is a schematic diagram of a management rewritable non-volatile memory module according to an exemplary embodiment of the present disclosure. Referring to FIG. 6, it is assumed that the rewritable non-volatile memory module 43 includes physical units 610(0) to 610 (B). When the memory storage device 10 is started (for example, for the first time), the memory management circuit 51 may perform an initialization operation to initialize the management information inside the memory storage device 10.

During the initialization operation, the memory management circuit 51 may classify the physical units 610(0) to 610(A) into the first type of physical units 61 and classify the physical units 610(A+1) to 610(B) into the second type of physical units 62. According to the classification result, the memory management circuit 51 may set the physical units 610(0) to 610(A) belonging to the first type of physical units 61 to be operated in a specific operation mode (also called the first operation mode) and set the physical units 610(A+1) to 610(B) belonging to the second type of physical units 62 to be operated in another operation mode (also called the second operation mode). The first operation mode is different from the second operation mode. In the first operation mode, a physical unit may be programmed based on a specific programming mode (also referred to as the first programming mode). Furthermore, in the second operation mode, a physical unit may be programmed based on another specific programming mode (also referred to as the second programming mode).

It should be noted that, in the initialization operation, the total number of physical units classified as the first type of physical units 61 (such as physical units 610(0) to 610(A)) and the total number of physical units classified as the second type of physical units 62 (such as physical units 610(A+1) to 610(B)) are both preset numbers. In addition, the rewritable non-volatile memory module 43 may also include other physical units, which is not limited by the present disclosure.

In an exemplary embodiment, in a physical unit programmed based on the first programming mode, a memory cell may be configured to store m bits of data. In an exemplary embodiment, in a physical unit programmed based on the second programming mode, a memory cell may be configured to store n bits of data, and m is greater than n. For example, n may be ‘1’, and m may be ‘2’, ‘3’ or ‘4’, and the present disclosure is not limited thereto. In an exemplary embodiment, n and m may also be other positive integers, as long as m is greater than n.

In an exemplary embodiment, the first programming mode refers to an MLC programming mode, a TLC programming mode, a QLC programming mode or the like.

For example, one memory cell programmed based on the MLC programming mode may store 2 bits of data, one memory cell programmed based on the TLC programming mode may store 3 bits of data, and one memory cell programmed based on the QLC programming mode may store 4 bits of data.

In an exemplary embodiment, the second programming mode refers to one of SLC programming mode, pseudo SLC programming mode, lower physical programming mode, mixture programming mode and less layer memory cell mode. In SLC programming mode and virtual SLC programming mode, a memory cell only stores one bit of data. In the lower physical programming mode, only the lower physical programming unit will be programmed, and the upper physical programming unit corresponding to the lower physical programming unit may not be programmed. In the mixture programming mode, valid data (or real data) will be programmed in the lower physical programming unit, and in the meantime, dummy data will be programmed into the upper physical programming unit corresponding to the lower physical programming unit below the valid data. In the less layer memory cell mode, only a part of the physical programming unit will be programmed to store valid data. For example, one memory cell programmed based on SLC programming mode, pseudo SLC programming mode, lower physical programming mode, mixture programming mode and less layer memory cell mode may store 1 bit of data. However, the total number of bits of data stored in a memory cell programmed based on the first programming mode and the second programming mode may also be adjusted according to practical needs, which is not limited by the present disclosure.

In an exemplary embodiment, the writing performance of the host writing operation performed through the second programming mode is higher than the writing performance of the host writing operation performed through the first programming mode. For example, when the host writes data X and data Y with the same amount of data respectively, the writing performance of writing data X into at least one physical unit belonging to the second type of physical unit 62 through the second programming mode may be higher than the writing performance of writing data Y into at least one physical unit belonging to the first type of physical unit 61 through the first programming mode. In an exemplary embodiment, the reliability of the data stored based on the second programming mode may also be higher than the reliability of the data stored based on the first programming mode.

In an exemplary embodiment, a physical unit operating in the first operation mode may only be programmed based on the first programming mode (e.g., TLC programming mode) to store data. However, a physical unit operating in the second operation mode may be programmed to store data based on one of a first programming mode (e.g., TLC programming mode) and a second programming mode (e.g., SLC programming mode). For example, at a certain point in time (such as when data from the host system 11 needs to be directly stored), at least one physical unit belonging to the second type of physical unit 62 may be set to be programmed based on the second programming mode, so as to improve the writing performance of the host writing. In addition, at another point in time (for example, when performing data transfer inside the rewritable non-volatile memory module 43), at least one physical unit belonging to the second type of physical unit 62 may be set to be programmed based on the first programming mode, so as to increase the data storage capacity of the rewritable non-volatile memory module 43.

In an exemplary embodiment, it is assumed that at least one physical unit (also referred to as a first physical unit) in the rewritable non-volatile memory module 43 is set to be operated in the first operation mode (that is, belongs to the first type of physical unit 61) in the initialization operation. For example, the first physical unit may be one or more physical units in the physical units 610(0) to 610(A) in FIG. 6. In this way, in the first operation mode, the first physical unit may be programmed based on the first programming mode. In an exemplary embodiment, the first operation mode may be regarded as a default operation mode of the first physical unit.

After performing the initialization operation, the memory management circuit 51 may receive a plurality of commands from the host system 11. The plurality of commands include a first command and a second command. The first command instructs to store data (also referred to as first data) to a specific logical unit (also referred to as first logical unit). For example, the first command may include a write command. According to the first command, the memory management circuit 51 may instruct the rewritable non-volatile memory module 43 to store the first data in at least one physical unit mapped by the first logical unit based on the first programming mode or the second programming mode. The second command instructs to mark data (also called second data) stored in a specific logical unit (also called second logical unit) as invalid data. For example, the second command may include a Trim command. According to the second command, the memory management circuit 51 may mark the second data stored in the second logic unit as invalid data. Thereafter, new data (i.e. more first data) from the host system 11 may be stored in the second logical unit.

In an exemplary embodiment, when the first physical unit is set to be operated in the first operation mode, in response to a specific condition (also referred to as a target condition) being satisfied, the memory management circuit 51 may change the operation mode of the first physical unit according to a second command, for example, setting the first physical unit to be operated in the second operation mode (equivalent to classifying the first physical unit as the second type of physical unit 62). In this way, in the second operation mode, the first physical unit may be programmed based on the second programming mode. In an exemplary embodiment, by switching the first physical unit to be operated in the second operation mode, the total number of the second type of physical units 62 may be increased, the probability of the second type of physical units 62 being used up, and/or the time point at which the second type of physical units 62 are used up may be deferred, thereby improving the writing performance of the host writing.

In an exemplary embodiment, when the first physical unit is set to be operated in the first operation mode and the target condition is satisfied, the memory management circuit 51 may determine whether the total number of received second command reaches a threshold (also referred to as the first threshold) and/or whether the total amount of the second data reaches a threshold (also referred to as the second threshold). For example, the first threshold may be 100, and the second threshold may be 4 GB, and the present disclosure is not limited thereto. For example, the total amount of the second data may be directly related to the total number of received second commands. For example, after receiving more second commands from the host system 11, the total number of the second commands and the total amount of the second data may be correspondingly increased.

In an exemplary embodiment, when the first physical unit is set to be operated in the first operation mode and the target condition is satisfied, in response to the total number of the second commands reaching the first threshold and/or the total amount of the second data reaching the second threshold, the operation of changing the operating mode of the first physical unit may be triggered. Under the circumstances, the memory management circuit 51 may set the first physical unit to be operated in the second operation mode. Furthermore, in an exemplary embodiment, if the total number of the second commands does not reach the first threshold and/or the total amount of the second data does not reach the second threshold, the operation of changing the operation mode of the first physical unit may not be triggered. Therefore, the memory management circuit 51 may not change the operation mode of the first physical unit (equivalent to maintaining the first physical unit to be operated in the first operation mode).

In an exemplary embodiment, when the first physical unit is set to be operated in the first operation mode, the memory management circuit 51 may determine whether the total amount of the first data reaches a threshold (also referred to as the third threshold) and/or whether the total amount of the data stored in the second operation mode (also referred to as the third data) reaches a threshold (also referred to as the fourth threshold). For example, the third threshold may be 75% of the total capacity of the rewritable non-volatile memory module 43, and the fourth threshold may be 6 GB, and the present disclosure is not limited thereto. For example, the total amount of the first data may be directly related to the total number of received first commands. For example, after receiving more first commands from the host system 11, the total amount of stored first data may increase correspondingly. In addition, the memory management circuit 51 may continuously monitor the usage status of the physical units currently belonging to the second type of physical units 62 to obtain the total amount of the third data currently stored in the second operation mode. For example, the memory management circuit 51 may obtain the total amount of the third data according to the total amount of the valid data currently stored in the second type of physical units 62.

In an exemplary embodiment, when the first physical unit is set to be operated in the first operation mode, in response to the total amount of the first data reaching the third threshold and/or the total amount of the third data reaching the fourth threshold, the memory management circuit 51 may determine that the target condition is satisfied. Furthermore, in an exemplary embodiment, if the total amount of the first data does not reach the third threshold and/or the total amount of the third data does not reach the fourth threshold, the memory management circuit 51 may determine that the target condition is not satisfied.

In an exemplary embodiment, in the operation of determining whether the target condition is satisfied, the memory management circuit 51 may first determine whether the total amount of the first data reaches a third threshold. In response to the total amount of the first data reaching the third threshold, the memory management circuit 51 may continue to determine whether the total amount of the third data stored in the second operation mode reaches the fourth threshold. Alternatively, in an exemplary embodiment, in the operation of determining whether the target condition is satisfied, the memory management circuit 51 may also first determine whether the total amount of the third data stored in the second operation mode reaches the fourth threshold. In response to the total amount of the third data reaching the fourth threshold, the memory management circuit 51 may continue to determine whether the total amount of the first data reaches the third threshold. However, if the total amount of the first data does not reach the third threshold or the total amount of the third data does not reach the fourth threshold, the memory management circuit 51 may determine that the target condition is not satisfied.

In an exemplary embodiment, after setting the first physical unit to be operated in the second operation mode, within a preset time frame, the memory management circuit 51 may maintain the first physical unit to be operated in the second operation mode. However, after exceeding the time frame, the memory management circuit 51 may revert the first physical unit to be operated in the first operation mode. For example, after setting the first physical unit to be operated in the second operation mode, the memory management circuit 51 may start a counter. The memory management circuit 51 may determine whether a time has exceeded the time frame according to the counting value of the counter.

In other words, in an exemplary embodiment, when the first physical unit is set to be operated in the first operation mode, in response to the target condition being met, the memory management circuit 51 may temporarily set the first physical unit to be operated in the second operation mode, instead of permanently switching the first physical unit to adopt the second operation mode. In this way, it is possible to try to improve the writing performance of the host writing in a short time. In addition, by temporarily changing the operation mode of the first physical unit, the interference to the default management mechanism of the physical unit may also be reduced as much as possible, thereby increasing the operational stability of the system.

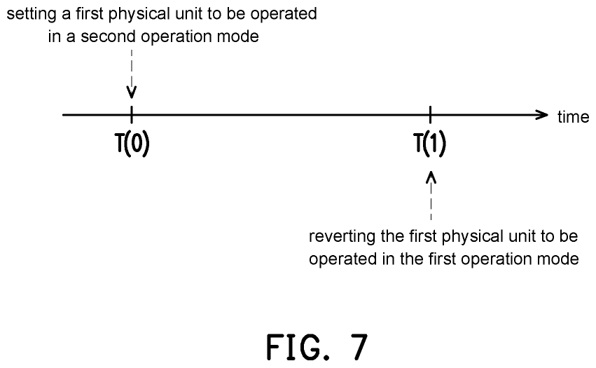

FIG. 7 is a schematic diagram illustrating changing the operation mode of the first physical unit according to an exemplary embodiment of the present disclosure. Referring to FIG. 7, assuming that the first physical unit is set to be operated in the first operation mode, at time T(0), the memory management circuit 51 sets the first physical unit to be operated in the second operation mode. Between time points T(0) and T(1) (i.e., within a preset time frame), the memory management circuit 51 may maintain the first physical unit to be operated in the second operation mode. Then, after the time point T(1) (that is, after exceeding the preset time frame), the memory management circuit 51 may revert the first physical unit to be operated in the first operation mode. For example, the preset time frame may be 10 seconds, and the present disclosure is not limited thereto.

In an exemplary embodiment, within the preset time frame, the memory management circuit 51 may further prohibit or defer the data consolidation operation. This data consolidation operation may release free physical units by moving (including copying) valid data. For example, the data consolidation operation may include a garbage collection (GC) operation. For example, a free physical unit refers to a physical unit that does not store valid data. For example, in the data consolidation operation, the memory management circuit 51 may collect valid data from the physical unit as the source unit and store the collected valid data in the physical unit as the target unit. Then, the physical unit that serves as the source unit may be marked as a free physical unit and may be erased. In addition, after exceeding the preset time frame, the memory management circuit 51 may release the control on the data consolidation operation. For example, after exceeding the preset time frame, the memory management circuit 51 may allow data consolidation operations that were previously prohibited or deferred to be performed. In an exemplary embodiment, by adding physical units that may be programmed based on the second programming mode and prohibiting or deferring the data consolidation operation within the predetermined time frame, it is possible to further improve the writing performance of the host writing.

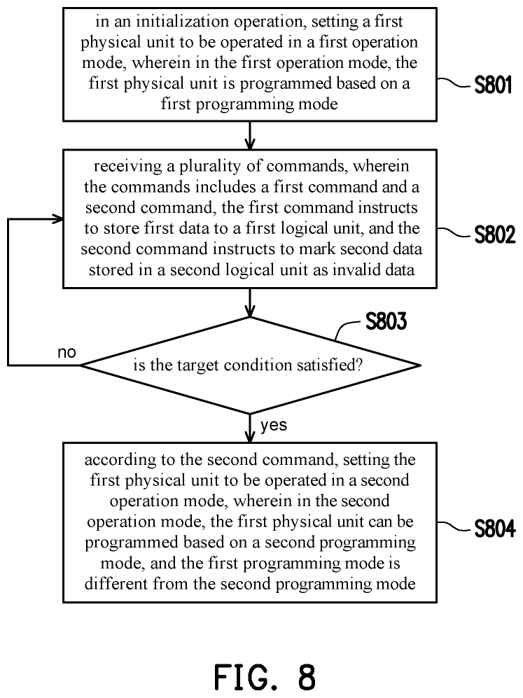

FIG. 8 is a flowchart of a memory management method according to an exemplary embodiment of the present disclosure. Referring to FIG. 8, in step S801, in the initialization operation, the first physical unit is set to be operated in a first operation mode, where in the first operation mode, the first physical unit is programmed based on the first programming mode. In step S802, a plurality of commands are received from the host system, where the plurality of commands include a first command and a second command, the first command instructs to store the first data into the first logic unit, and the second command instructs to mark the second data stored in the second logic unit as invalid data. In step S803, it is determined whether the target condition is satisfied. If the target condition is satisfied, in step S804, the first physical unit is set to be operated in a second operation mode according to the second command, where in the second operation mode, the first physical unit may be programmed based on the second programming mode, and the first programming mode is different from the second programming mode. In addition, if the target condition is not satisfied, then step S802 may be executed repeatedly.

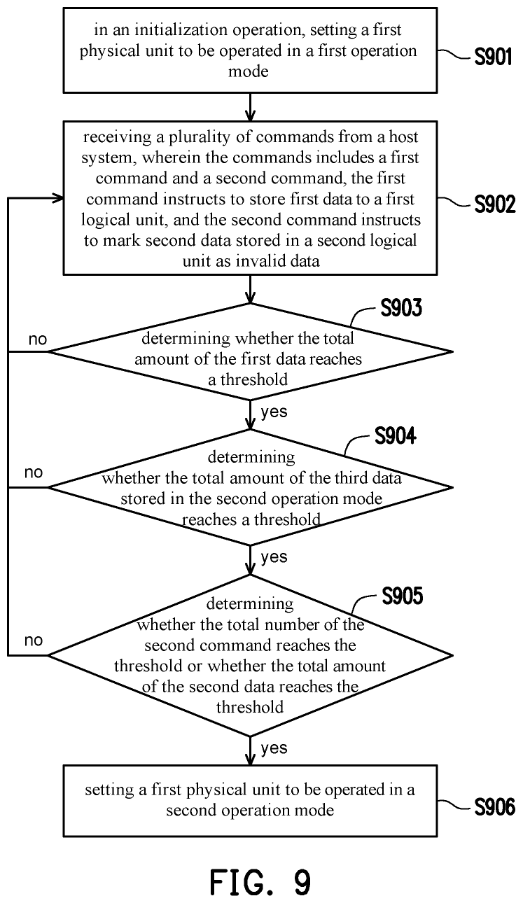

FIG. 9 is a flowchart of a memory management method according to an exemplary embodiment of the present disclosure. Referring to FIG. 9, in step S901, in an initialization operation, the first physical unit is set to be operated in a first operation mode. In step S902, multiple commands are received from the host system, where the multiple commands include a first command and a second command, the first command instructs to store the first data into the first logic unit, and the second command instructs to mark the second data stored into the second logic unit as invalid data. In step S903, it is determined whether the total amount of the first data reaches a threshold (i.e., a third threshold). If the total amount of the first data reaches the third threshold, in step S904, it is determined whether the total amount of the third data stored in the second operation mode reaches the threshold (i.e., the fourth threshold). If the total amount of the third data reaches the fourth threshold, in step S905, it is determined whether the total number of the second commands reaches the threshold (i.e., the first threshold) or whether the total amount of the second data reaches the threshold (i.e., the second threshold). If the total number of the second commands reaches the first threshold or the total amount of the second data reaches the second threshold, in step S906, the first physical unit is set to be operated in the second operation mode. In addition, if the determination result of steps S903, S904 and S905 is no, then step S902 may be repeatedly executed.

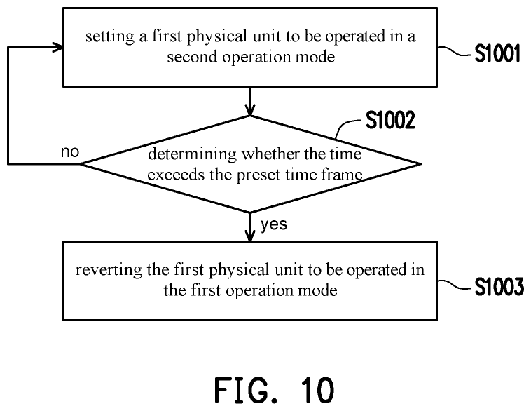

FIG. 10 is a flowchart of a memory management method according to an exemplary embodiment of the present disclosure. Referring to FIG. 10, in the case that the first physical unit is set to be operated in the first operation mode, in step S1001, the first physical unit is set to be operated in the second operation mode. In step S1002, it is determined whether the time exceeds the preset time frame. If the time has exceeded the preset time frame, in step S1003, the first physical unit is reverted to be operated in the first operation mode. In addition, if the time has not exceeded the preset time frame, the first physical unit may be maintained to be operated in the second operation mode.

However, the steps in FIG. 8 to FIG. 10 have been described in detail above, and will not be repeated here. It should be noted that each step in FIG. 8 to FIG. 10 may be implemented as a plurality of program codes or circuits, which is not limited by the present disclosure. In addition, the methods in FIG. 8 to FIG. 10 may be used together with the above exemplary embodiments, or may be used alone, which is not limited by the present disclosure.

To sum up, the memory management method, memory storage device, and memory control circuit unit provided by the exemplary embodiments of the present disclosure may change the operation mode of at least some of the physical units (i.e., the first physical unit) in the rewritable non-volatile memory module at a specific point in time or when specific conditions are met, for example, change the operation mode of the first physical unit from the first operation mode to the second operation mode, so as to improve the writing performance of the host writing. In addition, by changing the operation mode of the first physical unit temporarily rather than permanently, for example, reverting the operation mode of the first physical unit to the first operation mode (i.e., the default operation mode of the first physical unit) after a period of time, it is possible to reduce the interference to the default management mechanism of the physical unit, thereby increasing the operational stability of the system.

Although the present disclosure has been disclosed as above with the embodiments, it is not intended to limit the present disclosure. Any person with ordinary knowledge in the technical field may make some changes and modifications without departing from the spirit and scope of the present disclosure. Therefore, the scope of protection of the present disclosure should be as the criterion as defined by the scope of the appended claims.

What is claimed is:

1. A memory management method used for a rewritable non-volatile memory module, wherein the rewritable non-volatile memory module comprises a plurality of physical units, and the memory management method comprising:
in an initialization operation, setting a first physical unit among the plurality of physical units to be operated in a first operation mode, wherein in the first operation mode, the first physical unit is programmed based on a first programming mode;
receiving a plurality of commands from a host system, wherein the plurality of commands comprise a first command and a second command, the first command instructs to store a first data to a first logical unit, and the second command instructs to mark a second data stored in a second logical unit as an invalid data; and
in response to that a target condition is satisfied, setting the first physical unit to be operated in a second operation mode according to the second command, wherein in the second operation mode, the first physical unit is programmable based on a second programming mode, and the first programming mode is different from the second programming mode.

2. The memory management method according to claim 1, wherein the step of setting the first physical unit to be operated in the second operation mode according to the second command comprises:
in response to a total number of the second command reaching a first threshold or a total amount of the second data reaching a second threshold, setting the first physical unit to be operated in the second operation mode.

3. The memory management method according to claim 1, further comprising:
in response to at least one of a total amount of the first data reaching a third threshold and a total amount of a third data stored in the second operation mode reaching a fourth threshold, determining that the target condition is satisfied.

4. The memory management method according to claim 1, further comprising:
after setting the first physical unit to be operated in the second operation mode, maintaining the first physical unit to be operated in the second operation mode within a time frame; and
after exceeding the time frame, reverting the first physical unit to be operated in the first operation mode.

5. The memory management method according to claim 4, further comprising:
prohibiting or deferring execution of a data consolidation operation within the time frame, wherein the data consolidation operation releases a free physical unit by moving a valid data.

6. The memory management method according to claim 1, wherein in a physical unit programmed based on the first programming mode, a memory cell is configured to store m bits of data,
in a physical unit programmed based on the second programming mode, a memory cell is configured to store n bits of data, and m is greater than n.

7. The memory management method according to claim 1, wherein a writing performance of a host writing operation performed through the second programming mode is higher than a writing performance of a host writing operation performed through the first programming mode.

8. A memory storage device, comprising:
a connection interface unit, coupled to a host system;
a rewritable non-volatile memory module, comprising a plurality of physical units; and
a memory control circuit unit, coupled to the connection interface unit and the rewritable non-volatile memory module,
wherein the memory control circuit unit is configured to:
in an initialization operation, set a first physical unit among the plurality of physical units to be operated in a first operation mode, wherein in the first operation mode, the first physical unit is programmed based on a first programming mode;
receive a plurality of commands from the host system, wherein the plurality of commands comprise a first command and a second command, the first command instructs to store a first data into a first logical unit, and the second command instructs to mark a second data stored in a second logical unit as an invalid data; and
in response to a target condition being satisfied, set the first physical unit to be operated in a second operation mode according to the second command, wherein in the second operation mode, the first physical unit is programmable based on a second programming mode, and the first programming mode is different from the second programming mode.

9. The memory storage device according to claim 8, wherein the operation of setting the first physical unit to be operated in the second operation mode by the memory control circuit unit according to the second command comprises:
in response to a total number of the second command reaching a first threshold or a total amount of the second data reaching a second threshold, set the first physical unit to be operated in the second operation mode.

10. The memory storage device according to claim 8, wherein the memory control circuit unit is further configured to:
in response to at least one of a total amount of the first data reaching a third threshold and a total amount of a third data stored in the second operation mode reaching a fourth threshold, determine that the target condition is satisfied.

11. The memory storage device according to claim 8, wherein the memory control circuit unit is further configured to:
after setting the first physical unit to be operated in the second operation mode, maintain the first physical unit to be operated in the second operation mode within a time frame; and
after exceeding the time frame, revert the first physical unit to be operated in the first operation mode.

12. The memory storage device according to claim 11, wherein the memory control circuit unit is further configured to:
prohibit or defer execution of a data consolidation operation within the time frame, wherein the data consolidation operation releases a free physical unit by moving a valid data.

13. The memory storage device according to claim 8, wherein in a physical unit programmed based on the first programming mode, a memory cell is configured to store m bits of data,
in a physical unit programmed based on the second programming mode, a memory cell is configured to store n bits of data, and m is greater than n.

14. The memory storage device according to claim 8, wherein a writing performance of a host writing operation performed through the second programming mode is higher than a writing performance of a host writing operation performed through the first programming mode.

15. A memory control circuit unit, configured to control a rewritable non-volatile memory module, wherein the rewritable non-volatile memory module comprises a plurality of physical units, and the memory control circuit unit comprises:
a host interface, coupled to a host system;
a memory interface, coupled to the rewritable non-volatile memory module; and
a memory management circuit, coupled to the host interface and the memory interface,
wherein the memory management circuit is configured to:
in an initialization operation, set a first physical unit among the plurality of physical units to be operated in a first operation mode, wherein in the first operation mode, the first physical unit is programmed based on a first programming mode;
receive a plurality of commands from the host system, wherein the plurality of commands comprise a first command and a second command, the first command instructs to store a first data into a first logical unit, and the second command instructs to mark a second data stored in a second logical unit as an invalid data; and
in response to a target condition being satisfied, set the first physical unit to be operated in a second operation mode according to the second command, wherein in the second operation mode, the first physical unit is programmable based on a second programming mode, and the first programming mode is different from the second programming mode.

16. The memory control circuit unit according to claim 15, wherein the operation of setting the first physical unit to be operated in the second operation mode by the memory management circuit according to the second command comprises:
in response to a total number of the second command reaching a first threshold or a total amount of the second data reaching a second threshold, setting the first physical unit to be operated in the second operation mode.

17. The memory control circuit unit according to claim 15, wherein the memory management circuit is further configured to:
in response to at least one of a total amount of the first data reaching a third threshold and a total amount of a third data stored in the second operation mode reaching a fourth threshold, determine that the target condition is satisfied.

18. The memory control circuit unit according to claim 15, wherein the memory management circuit is further configured to:
after setting the first physical unit to be operated in the second operation mode, maintain the first physical unit to be operated in the second operation mode within a time frame; and
after exceeding the time frame, revert the first physical unit to be operated in the first operation mode.

19. The memory control circuit unit according to claim 18, wherein the memory management circuit is further configured to:
prohibit or defer execution of a data consolidation operation within the time frame, wherein the data consolidation operation releases a free physical unit by moving a valid data.

20. The memory control circuit unit according to claim 15, wherein in a physical unit programmed based on the first programming mode, a memory cell is configured to store m bits of data,
in a physical unit programmed based on the second programming mode, a memory cell is configured to store n bits of data, and m is greater than n.

21. The memory control circuit unit according to claim 15, wherein a writing performance of a host writing operation performed through the second programming mode is higher than a writing performance of a host writing operation performed through the first programming mode.
